(19) United States
(12) Patent Application Publication
(10) Pub. No.: US 2026/0289197 A1
(43) Pub. Date: Sep. 24, 2026

(54) METHOD, APPARATUS, AND PROGRAM FOR TRANSLATING SIGN LANGUAGE VIDEO

(71) Applicant: RISO KAGAKU CORPORATION, Tokyo (JP)

(72) Inventors: Ryuji MURABAYASHI, Tokyo (JP); Arocha MAHAPANNAPORN, Tokyo (JP)

(73) Assignee: RISO KAGAKU CORPORATION, Tokyo (JP)

(21) Appl. No.: 19/563,239

(22) Filed: Mar. 11, 2026

(30) Foreign Application Priority Data
Mar. 21, 2025 (JP) 2025-046563

(51) Int. Cl. G06F 40/58; G06V 10/26; G06V 40/20

(52) U.S. Cl. CPC G06F 40/58; G06V 10/26; G06V 40/20

(57) ABSTRACT

A sign language video translating apparatus includes: a sign language video segmenting unit that segments information related to a sign language video obtained by capturing sign language gestures based on predefined conditions to generate chronologically ordered sign language video information; a translating unit that translates the chronologically ordered segmented sign language video information to generate words; a sentence generating unit that generates sentences using sequences of words which are periodically grouped from the chronologically ordered words generated by the translating unit; and a display control unit that sequentially updates and displays the sentences which are periodically generated by the sentence generating unit.

### CROSS-REFERENCE TO RELATED APPLICATIONS

The present application claims priority under 35 U.S.C. § 119 to Japanese Patent Application No. 2025-046563, filed on Mar. 21, 2025. The above applications are hereby expressly incorporated by reference, in these entireties, into the present application.

### BACKGROUND OF THE INVENTION

### 1. Field of the Invention

The present disclosure is related to a sign language video translating apparatus, a sign language video translating method, a sign language video translating program, and a sign language video translating system for translating a sign language video obtained by capturing sign language gestures, generating text, and displaying the generated text.

### 2. Description of the Related Art

Conventionally, when hearing individuals (persons without hearing impairments) and hearing impaired individuals (persons with hearing impairments) communicate, a method is generally used where speech by the hearing person is converted into text for the hearing impaired person to read, and the hearing impaired person responds via keyboard input or handwriting. However, in situations requiring quick and accurate communication, such as meetings, methods relying on keyboard input or handwriting can be insufficient.

Recently, various technologies have been proposed to solve this problem by capturing sign language gestures employing a camera and translating the captured sign language video.

For example, in “Ronglai Zuo, Fangyun Wei, Brian Mak, ‘Towards Online Sign Language Recognition and Translation’, arXiv: 2401.05336v1 [cs.CV], 10 Jan. 2024” (Non-Patent Document 1) proposes dividing sign language videos into segments using a fixed time window (sliding window) and translating the segments into words using a pre-trained isolated sign recognition model.

In addition, “Yurika Doi, Takuma Yagi, Tomohito Mizuguchi, ‘Development of a Sign Language Recognition System Using CNN-LSTM’, Proceedings of the Japanese Society for Artificial Intelligence Research Group, SIG-AGI-001-06, Dec. 15, 2015” (Non-Patent Document 2) proposes recognizing sign language videos and generating sentences using a CNN (Convolutional Neural Network) and LSTM (Long Short Term Memory).

Further, Japanese Unexamined Patent Publication No. 2015-76774 proposes a technique that combines speech recognition with sign language recognition to improve translation accuracy.

### SUMMARY OF THE INVENTION

However, although Non-Patent Document 1 can obtain word sequences in real time, it does not propose any method for generating sentences using these word sequences.

In addition, in Non-Patent Document 2, since sign language videos are translated at the sentence level, when the sign language is lengthy, there is no clue regarding the content thereof until the result of translation is obtained, causing it to be difficult to understand.

Further, in Japanese Patent Application Publication No. 2015-76774, accuracy decreases when audio information is absent or when only sign language is recognized.

The present disclosure has been developed in view of the foregoing circumstances. The present disclosure provides a sign language video translating apparatus, a sign language video translating method, and a sign language video translating program capable of recognizing the content of sign language in real time without waiting for output of a result of translation for a single sentence.

A sign language video translating apparatus of the present disclosure is equipped with: a sign language video segmenting unit that segments information related to a sign language video obtained by capturing sign language gestures based on preset conditions to generate segmented sign language video information in chronological order; a translating unit that translates the chronologically ordered segmented sign language video information to generate words; a sentence generating unit that generates sentences using sequences of words which are periodically grouped from the chronologically ordered words generated by the translating unit; and a display control unit that sequentially updates and displays the sentences which are periodically generated by the sentence generating unit.

According to the sign language video translating apparatus of the present disclosure, information related to a sign language video obtained by capturing sign language gestures is segmented to generate segmented sign language video information in chronological order. The chronologically ordered sign language video information is translated to generate words. Sentences are then generated using word sequences periodically grouped from the chronologically ordered words. The generated sentences are displayed while being sequentially updated. As a result, the content of the sign language can be recognized in real time without having to wait for the output of the translation result for a single sentence.

### BRIEF DESCRIPTION OF THE DRAWINGS

FIG. 1 is a block diagram that illustrates the schematic configuration of an embodiment of a sign language video translation system that employs an embodiment of a sign language video translating apparatus of the present disclosure.

FIG. 2A is a collection of graphs that show changes in velocity before normalization and changes in velocity after normalization based on a shoulder width of three feature points.

FIG. 2B is a collection of graphs that show changes in velocity after normalization based on a shoulder width of three feature points.

FIG. 3 is a flowchart for explaining the flow of processes performed by the sign language video translation system illustrated in FIG. 1.

FIG. 4 is a diagram for explaining the flow of processes which are performed by the sign language video translation system illustrated in FIG. 1.

### DETAILED DESCRIPTION OF THE EMBODIMENTS

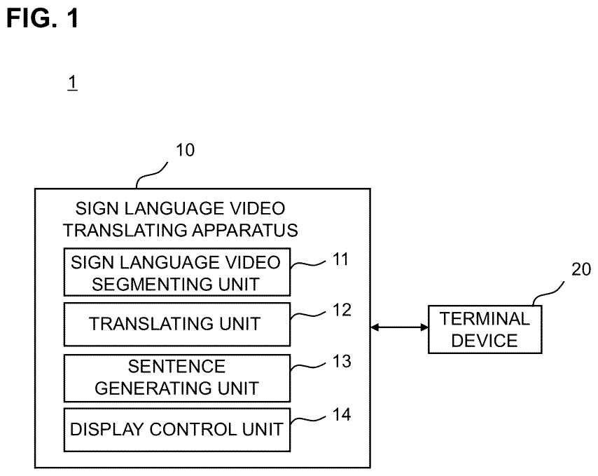

A sign language video translation system 1 that employs an embodiment of a sign language video translating apparatus of the present disclosure will be described in detail below, with reference to the attached drawings. FIG. 1 is a block diagram that illustrates the schematic configuration of the sign language video translation system 1 of the present embodiment.

The sign language video translation system 1 of the present embodiment is a system that translates and displays sign language videos in which sign language gestures are captured. Specifically, it is a system that translates sign language videos in units of individual words, and updates and displays a sentence each time a new word is added.

As illustrated in FIG. 1, the sign language video translation system 1 of the present embodiment is equipped with a sign language video translating apparatus 10 and a terminal device 20 equipped with a camera for capturing sign language gestures.

The sign language video translating apparatus 10 and the terminal device 20 are connected via communication lines such as the Internet or a LAN (Local Area Network), and are configured to be capable of exchanging various information between them.

As illustrated in FIG. 1, the sign language video translating apparatus 10 is equipped with a sign language video segmenting unit 11, a translating unit 12, a sentence generating unit 13, and a display control unit 14.

The sign language video segmenting unit 11 segments information related to sign language videos captured by the terminal device 20 based on preset conditions, and generates segmented sign language video information in chronological order.

Specifically, the sign language video segmenting unit 11 first extracts feature points (also called landmarks) from each frame image that constitutes an input sign language video. Feature points include the positions of joints and fingertips related to sign language, for example. Feature points may also be extracted not only from hand movements but also from facial movements and expressions, as well as movements involving the arms and body. Existing image processing techniques may be employed in the feature point extracting process. Alternatively, a machine learning model trained with the feature points may be employed to extract the feature points.

The sign language video segmenting unit 11 then generates the chronologically ordered segmented sign language video information described above by employing the feature points which are extracted from each frame image. The sign language video segmenting unit 11 of the present embodiment generates the chronologically ordered segmented sign language video information by segmenting (classifying) the feature points of a series of frame images into units of actions employing the positions, angles, etc., of each body part.

More specifically, the sign language video segmenting unit 11, for example, determines the coordinates of the center position of the palm from extracted hand feature points and segments the video at points where the speed of movement of the center position of the palm exceeds a predetermined threshold value as action segments. In addition, the sign language video segmenting unit 11 calculates the coordinates of the center position of a face from extracted facial feature points and the coordinates of the center position of the palm from the hand feature points. The sign language segmenting unit 11 then calculates the angular velocity of the center position of the palm relative to the center position of the face and segments the video at points where the angular velocity exceeds a predetermined threshold value as action segments.

Recognizing action segments using velocity information derived from feature points in this manner is employed because there is a tendency for hand movements to accelerate in sign language gestures.

In addition in the case that the input sign language video is segmented based on the velocity information of coordinate values obtained from feature points such as the hand and face and threshold values as described above, appropriate threshold values may vary depending on the distance from the terminal device 20 (camera) or differences in the physique of the person performing the sign language gestures. As a solution, a method that conducts calibration initially may be considered. However, such a method is cumbersome and cannot address cases where the distance of the terminal device 20 (camera) changes frequently.

Therefore, the coordinate values of feature points in each frame image may be normalized by the shoulder width of the person performing the sign language gestures in the frame images. In this case, the threshold values are also set in advance based on the normalized values. Normalization by shoulder width is performed, for example, by the operation below.

The coordinates of the right shoulder at a time t are designated as xᵣₛ(t) and yᵣₛ(t), and the coordinates of the left shoulder at the time t are designated as xₗₛ(t) and yₗₛ(t). The shoulder width d (t) at this time is calculated by Formula (1) below.

$$d ( t ) = \sqrt{{( {x}_{rs} ( t ) - {x}_{ls} ( t ) )}^{2} + {( {y}_{rs} ( t ) - {y}_{ls} ( t ) )}^{2}} \qquad ( 1 )$$

A right-hand velocity v_{rh_n}(t) normalized by the shoulder width at this point in time is calculated employing the unnormalized right-hand coordinates xᵣₕ(t) and yᵣₕ(t) by Formula (2) below.

$${v}_{rh \_ n} ( t ) = \sqrt{{( \frac{{x}_{rh} ( t ) - {x}_{rh} ( t - 1 )}{d ( t )} )}^{2} + {( \frac{{y}_{rh} ( t ) - {y}_{rh} ( t - 1 )}{d ( t )} )}^{2}} = \frac{{v}_{rh} ( t )}{d ( t )} \qquad ( 2 )$$

By performing normalization employing the shoulder width in this manner, differences in distance from the terminal device 20 (camera) and differences in the physique of the person performing sign language gestures can be ignored.

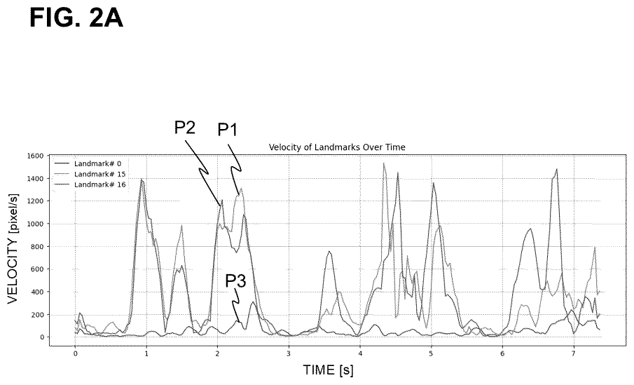

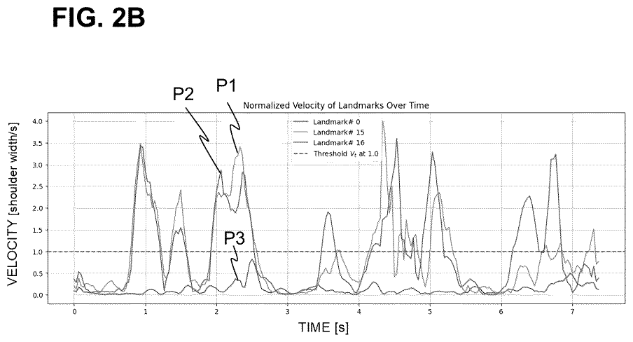

FIG. 2A is a graph that shows changes in velocity (in units of [pixels/s]) of three feature points (P1, P2, P3) of the right hand before normalization. FIG. 2B is a graph that shows changes in velocity (in units of [shoulder width/s]) of the three feature points (P1, P2, P3) of the right hand after normalization by shoulder width. As illustrated in FIGS. 2A and 2B, it can be seen that there is no change in the changes in velocity of the three feature points prior to and following normalization by shoulder width.

In the description above, normalization was performed employing shoulder width. However, the present disclosure is not limited to this method. Any two feature points (body size information) that appear as a constant width in the image captured by the terminal device 20 (camera), regardless of sign language gestures or posture, may be employed. Two feature points that indicate the size of a head may be employed, for example.

In addition, in the case that the coordinate values of the feature points extracted from each frame image contain noise, segmentation may frequently occur at unintended locations. Therefore, noise may be removed by applying a moving average over a predetermined time window with respect to the coordinate values of each feature point.

Alternatively, instead of using feature points as described above, segmented sign language video information may be generated by dividing the video at predetermined intervals, such as 0.5 second intervals.

The translating unit 12 translates the chronologically ordered segmented sign language video information generated by the sign language video segmenting unit 11 to generate words. Specifically, the translating unit 12 of the present embodiment determines words by inputting the segmented sign language video information to a machine learned isolated sign recognition model. Each piece of the chronologically ordered segmented sign language video information is input to the isolated sign recognition model, and words that correspond to each piece of segmented sign language video information are determined. The sentence generating unit 13 generates sentences using sequences of words which are periodically grouped from the chronologically ordered words generated by the translating unit 12.

The sentence generating unit 13 of the present embodiment performs a preliminary process prior to generating the sentences. As the preliminary process, the sentence generating unit 13 first deletes one of any redundant words that appear before or after a predetermined word within the chronologically ordered sequences of words. Sign language may involve repetitive gestures, and the number of repetitions may vary between persons who perform sign language gestures. In such cases, words generated by the translating unit 12 may be duplicated, and therefore these duplicates are removed.

Next, after deleting redundant words as described above, the sentence generating unit 13 identifies combinations of a predetermined word and the word immediately preceding or following the predetermined word. In the case that the combination matches a predefined pair, it converts it to a predefined alternative word. Specifically, in the case that a combination is of “first time” and “meet”, for example, these words are converted to “nice to meet you”. Similarly, in the case that a combination is of “today” and “night”, these words are converted to “tonight”. In the case that a combination is of “today” and “morning” these words are converted to “this morning”. That is, the sentence generating unit 13 converts word combinations to other synonymous words.

The sentence generating unit 13 has a dictionary table, in which word combinations as described above are associated with corresponding words (other words which are synonymous with the word combinations) set in advance therein. The sentence generating unit 13 refers to the dictionary table to perform word conversion.

Next, after performing the word conversion described above, the sentence generating unit 13 generates a sequence of words by periodically grouping words in chronological order. It then generates a sentence by inputting this sequence of words into a large language model (LLM).

Specifically, the sentence generating unit 13 sequentially accumulates chronologically ordered words in a buffer. Each time a new word is input into the buffer, the sequence of words accumulated in the buffer up to that point is input into the large language model to generate a sentence. That is, in the present embodiment, for every n words or sequences of words (where n is a natural number of 1 or greater), a new sentence is generated and the text is updated whenever an (n+1)th new word is added. In the present embodiment, sentences are generated not in units of single sentences, but by employing the sequence of words which is accumulated in the buffer before all of the words that constitute a sentence are gathered.

In the case that the sentence generating unit 13 detects a sentence segment from the chronologically ordered words, it clears the word sequence stored in the buffer.

Note that in the present embodiment, the method for periodically grouping the chronologically ordered words involves generating a sequence of words each time a new word is input, as described above. However, the method for periodically grouping words is not limited to such a configuration. For example, it is also possible to generate a word sequence by grouping words which are accumulated in the buffer at predetermined temporal intervals.

In addition, when inputting sequences of words into the large language model as described above, the sentence generating unit 13 simultaneously inputs the grammatical rules of sign language. Examples of grammatical rules of sign language include: “The sign for ‘did’ changes the preceding verb to the past tense” or “The sign for ‘place’ functions as the prepositions ‘to’ or ‘at’”, for example. These rules are input into the large language model as prompts. Note that the grammatical rules of sign language are not limited to these examples, and other known grammatical rules may also be input.

Large language models that may be employed include natural language processing models such as ChatGPT (registered trademark), Microsoft 365 Copilot (registered trademark), and Gemini (registered trademark). However, the present disclosure is not limited to employing these large language models, and other known technologies may also be employed to generate text.

The display control unit 14 sequentially updates and displays the sentences which are periodically generated by the sentence generating unit 13. The destination for display of the sentences may be a display device such as a monitor connected to the sign language video translating apparatus 10, or another terminal device (not shown).

The sign language video translating apparatus 10 includes a CPU (Central Processing Unit), semiconductor memory such as a ROM (Read Only Memory) and a RAM (Random Access Memory), storage such as a hard disk, and a communication I/F (Interface).

The storage of the sign language video translating apparatus 10 has an embodiment of a sign language video translation program of the present disclosure installed therein. The functions of the aforementioned components of the sign language video translating apparatus 10 are executed by the CPU launching the sign language video translation program.

In the present embodiment, the functions of each component are executed by the CPU executing the sign language video translation program. However, some or all of the functions executed by the sign language video translation program may be implemented using hardware such as a GPU (Graphics Processing Unit), an ASIC (Application Specific Integrated Circuit), an FPGA (Field-Programmable Gate Array), or other electronic circuits.

Next, the terminal device 20 will be described.

The terminal device 20 is used by the person who performs sign language gestures as described above, and is constituted by a mobile device such as a tablet terminal or a smartphone. However, the present disclosure is not limited to such a configuration, and the terminal device may be constituted by a personal computer.

The terminal device 20 has a camera and captures sign language gestures of the person who performs the sign language gestures. The sign language video captured by the terminal device 20 is transmitted to the sign language video translating apparatus 10.

Note that in the present embodiment, the terminal device 20 captures sign language gestures. However, the present disclosure is not limited to such a configuration. Alternatively, sign language gestures may be captured by a simple camera.

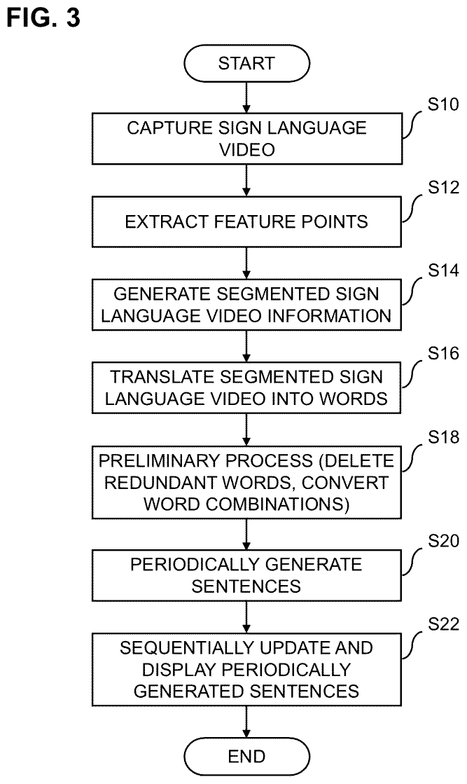

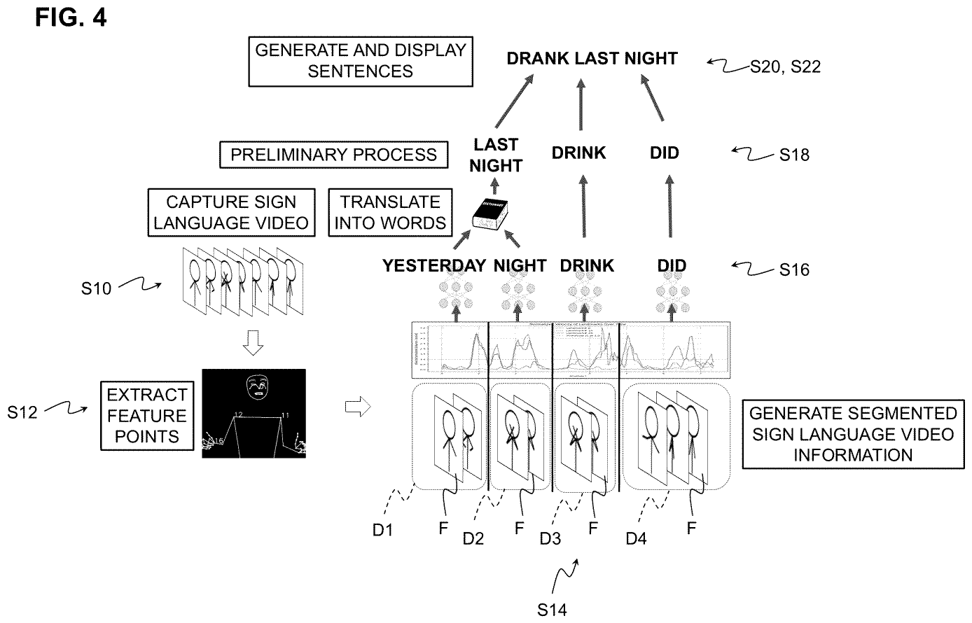

Next, the flow of processes performed by the sign language video translation system 1 of the present embodiment will be described with reference to the flowchart illustrated in FIG. 3 and the explanatory diagram illustrated in FIG. 4.

First, sign language gestures are captured employing the terminal device 20 (S10), and a captured sign language video is transmitted to the sign language video translating apparatus 10.

The sign language video translating apparatus 10 receives the sign language video transmitted from the terminal device 20. Feature points are extracted from each frame image of the sign language video by the sign language video segmenting unit 11 (S12).

Next, the sign language video segmenting unit 11 segments the feature points of a series of frame images into action units to generate chronologically ordered segmented sign language video information (S14). Note that F in FIG. 4 represents the feature points of each frame image, and D1, D2, D3, D4 in FIG. 3 represent the segmented sign language video information.

Thereafter, the chronologically ordered segmented sign language video information is input to the translating unit 12, which translates the input segmented sign language video information into words (S16). In the example illustrated in FIG. 3, the segmented sign language video information D1 to D4 are translated into “yesterday”, “night”, “drink”, and “did”, respectively.

The chronologically ordered words translated by the translating unit 12 are then input to the sentence generating unit 13, which performs the preliminary process described above (S18). Specifically, it removes preceding and following redundant words as described above, and converts predefined combinations of words into other words. In the example illustrated in FIG. 4, the combination of “yesterday” and “night” is converted to “last night”.

Next, the sentence generating unit 13 generates a sequence of words by periodically grouping the chronologically ordered words. The sentence generating unit 13 then generates sentences by inputting these word sequences and grammatical rules for sign language into a large language model (S20). In the present embodiment, a sentence is generated each time a new word is added as described above. Therefore, in the example illustrated in FIG. 4, a sentence constituted by the two word “last night” is first generated, followed by the sentence “last night, drink”, constituted by the three words “last night” and “drink”. Therefore, inputting the word “did” and the sign language rule “When ‘did’ comes, the preceding word becomes past tense” generates the sentence “Drank last night” constituted by the four words “last night”, “drink”, and “did.”

Then, the display control unit 14 sequentially updates and displays the sentences which are periodically generated by the sentence generating unit 13 (S22). In the example illustrated in FIG. 4, first, only the word “last night” is displayed, then the sentence “Last night, drink” is displayed, and finally, the sentence “Drank last night” is displayed.

Note that in addition to displaying sentences which are periodically generated in step S22, it is also possible to display words generated in step S16 (such as “yesterday”, “night”, “drink”, and “did” in the example illustrated in FIG. 4) or words generated in step S18 (such as “last night”, “drink”, and “did” in the example illustrated in FIG. 4) in parallel. In addition, a plurality of patterns of translations may be generated and displayed in parallel, and a user may be enabled to select from among the displayed plurality of patterns. The plurality of patterns of translations may include, in addition to the sequences of words generated in steps S16 and S18 described above, translations that employ the grammatical rules of different sign languages, or translations that employ synonyms or similar words for the same sign.

According to the sign language video translation system 1 of the embodiment described above, information related to a sign language video in which sign language gestures are captured is divided into segments to generate chronologically ordered sign language video information. The chronologically ordered segmented sign language video information is translated to generate words. Sentences are generated employing sequences of words which are periodically grouped from the chronologically ordered words, and the generated sentences are displayed while being sequentially updated. Thereby, real time recognition of the content of sign language is enabled without waiting for the output of the translation result for a single sentence.

In addition, in the sign language video translation system 1 of the embodiment described above, sentences are generated by inputting the sequences of words and grammatical rules for sign language into a large language model. This feature enhances the accuracy of translation and enables the generation of easily understandable sentences.

Further, in the sign language video translation system 1 of the embodiment described above, in the case that a predetermined word and the word preceding or following it form a predefined combination, the predetermined word and the preceding or following word are converted into another predefined word. This feature enables the generation of more understandable sentences.

Still further, in the sign language video translation system 1 of the embodiment described above, segmented sign language video information is generated using feature points extracted from the sign language video. This feature enables more appropriate segmentation through simple computational processing.

Still yet further, in the sign language video translation system 1 of the embodiment described above, segmented sign language video information is generated employing velocity information of the feature points. This feature enables high precision and more appropriate segmentation.

In addition, in the sign language video translation system 1 of the embodiment described above, in the case that the coordinate values of the feature points are normalized using the shoulder width of the person performing sign language gestures, more appropriate segmented sign language video information can be generated regardless of the physique of the person performing sign language gestures or the distance to the terminal device 20 (camera).

Further, the present disclosure is not limited to the embodiment described above and may be realized by modifying the components thereof within a scope that does not stray from its essence during implementation. Various inventions may also be formed by appropriately combining multiple components which are disclosed in the above embodiment. For example, all of the components which are disclosed in the above embodiment may be appropriately combined. It goes without saying that various modifications and applications are possible within a scope that does not stray from the spirit of the disclosure.

The following additional items are disclosed with respect to the present disclosure.

### (Item 1)

The sign language video translating apparatus of the present disclosure is equipped with: a sign language video segmenting unit that segments information related to a sign language video obtained by capturing sign language gestures based on preset conditions to generate chronologically ordered segmented sign language video information; a translating unit that translates the chronologically ordered segmented sign language video information to generate words; a sentence generating unit that generates sentences using sequences of words which are periodically grouped from the chronologically ordered words generated by the translating unit; and a display control unit that sequentially updates and displays the sentences which are periodically generated by the sentence generating unit.

### (Item 2)

In the sign language video translating apparatus according to Item 1, the sentence generating unit may generate sentences by inputting the sequences of words and grammatical rules for sign language into a large language model.

### (Item 3)

In the sign language video translating apparatus according to Item 1 or 2, the sentence generating unit may convert a predetermined word and the word preceding or following it into another predetermined word in the case that the combination of the predetermined word and the preceding or following word corresponds to a preset combination.

### (Item 4)

In the sign language video translating apparatus according to any one of Items 1 to 3, the sign language video segmenting unit may obtain feature points which are extracted from a video obtained by captured sign language gestures as information related to the sign language video and employ the feature points to generate the segmented sign language video information.

### (Item 5)

In the sign language video translating apparatus according to Item 4, the sign language video segmenting unit may generate the segmented sign language video information by employing velocity information of the feature points.

### (Item 6)

In the sign language video translating apparatus according to Item 4 or 5, the sign language video segmenting unit may normalize the coordinate values of the feature points using physique information of a person performing sign language gestures.

### (Item 7)

A sign language video translating method of the present disclosure generates chronologically ordered segmented sign language video information by segmenting information related to a sign language video obtained by capturing sign language gestures based on preset conditions, translates the generated chronologically ordered segmented sign language video information to generate words, generates sentences using sequences of words which are periodically grouped from the generated chronologically ordered words, and sequentially updates and displays the periodically generated sentences.

### (Item 8)

A sign language video translating program of the present disclosure causes a computer to execute the steps of: segmenting information related to a sign language video obtained by capturing sign language gestures into chronologically ordered segmented sign language video information based on preset conditions; translating the generated chronologically ordered segmented sign language video information to generate words; generating sentences employing sequences of words which are generated by periodically grouping the generated chronologically ordered words; and sequentially updating and displaying the periodically generated sentences.

What is claimed is:

1. A sign language video translating apparatus comprising:
a sign language video segmenting unit that segments information related to a sign language video obtained by capturing sign language gestures based on preset conditions to generate chronologically ordered segmented sign language video information;
a translating unit that translates the chronologically ordered segmented sign language video information to generate words;
a sentence generating unit that generates sentences using sequences of words which are periodically grouped from the chronologically ordered words generated by the translating unit; and
a display control unit that sequentially updates and displays the sentences which are periodically generated by the sentence generating unit.

2. The sign language video translating apparatus according to claim 1, wherein:
the sentence generating unit generates sentences by inputting the sequences of words and grammatical rules for sign language into a large language model.

3. The sign language video translating apparatus according to claim 1, wherein:
the sentence generating unit converts a predetermined word and the word preceding or following it into another predetermined word in the case that the combination of the predetermined word and the preceding or following word corresponds to a preset combination.

4. The sign language video translating apparatus according to claim 1, wherein:
the sign language video segmenting unit obtains feature points which are extracted from the video obtained by captured sign language gestures as information related to the sign language video and employs the feature points to generate the segmented sign language video information.

5. The sign language video translating apparatus according to claim 4, wherein:
the sign language video segmenting unit generates the segmented sign language video information by employing velocity information of the feature points.

6. The sign language video translating apparatus according to claim 4, wherein:
the sign language video segmenting unit normalizes the coordinate values of the feature points using physique information of a person performing sign language gestures.

7. The sign language video translating apparatus according to claim 5, wherein:
the sign language video segmenting unit normalizes the coordinate values of the feature points using physique information of a person performing sign language gestures.

8. A sign language video translating method comprising:
generating chronologically ordered segmented sign language video information by segmenting information related to a sign language video obtained by capturing sign language gestures based on preset conditions;
translating the generated chronologically ordered segmented sign language video information to generate words;
generating sentences using sequences of words which are periodically grouped from the generated chronologically ordered words; and
sequentially updating and displaying the periodically generated sentences.

9. A non-transitory computer-readable recording medium containing a program for translating sign language video that causes a computer to execute the steps of:
generating chronologically ordered segmented sign language video information by segmenting information related to a sign language video obtained by capturing sign language gestures based on preset conditions;
translating the generated chronologically ordered segmented sign language video information to generate words;
generating sentences using sequences of words which are periodically grouped from the generated chronologically ordered words; and
sequentially updating and displaying the periodically generated sentences.
